(19) United States
(12) Patent Application Publication
(10) Pub. No.: US 2026/0296059 A1
(43) Pub. Date: Oct. 1, 2026

(54) IMAGE FORMING APPARATUS

(71) Applicant: KYOCERA DOCUMENT SOLUTIONS INC., OSAKA (JP)

(72) Inventor: NOBUHIRO MAEZAWA, OSAKA (JP)

(21) Appl. No.: 19/557,070

(22) Filed: Mar. 4, 2026

(30) Foreign Application Priority Data
Mar. 25, 2025 (JP) 2025-049300

(51) Int. Cl. B41J 11/00; B41J 3/407

(52) U.S. Cl. CPC B41J 11/0015; B41J 3/407

(57) ABSTRACT

An image forming apparatus includes a printing section, a UV irradiation section, and a UV control section. The printing section is configured to be capable of forming an image by applying ink to a printing base material. The UV irradiation section irradiates the printing base material with ultraviolet rays before the application of the ink to the printing base material. The UV control section controls a period of time for which the ultraviolet rays are irradiated, on the basis of glossiness of a face of the printing base material, where the ink is applied to the face of the printing base material.

### CROSS-REFERENCE TO RELATED PATENT APPLICATION

This application claims the benefit of Japanese Priority Patent Application JP 2025-049300 filed Mar. 25, 2025, the entire contents of which are incorporated herein by reference.

### FIELD OF THE DISCLOSURE

The present disclosure relates to an image forming apparatus that is applicable to, for example, printing on a recording medium.

### BACKGROUND OF THE DISCLOSURE

In related art, a technology is disclosed that improves adhesion of ink printed on a printing base material to prevent the ink from being removed from the printing base material.

For example, Japanese Patent No. 5808224 discloses performing a corona treatment or a UV treatment, performing treatment using a pretreatment agent such as an amine-based silane coupling agent, and using, as a coloring material, pigment encapsulated with a resin containing an epoxy group, which makes it possible to strongly fix print. However, with respect to the technology disclosed in Japanese Patent No. 5808224, the ink has a poor shelf life, and reduced reactivity and poor ink adhesion are exhibited when the ink is used after being left as it is for a long time. This may result in the ink being removed from a printing base material.

Further, Japanese Patent No. 5728876 discloses maintaining a discharge amount constant by increasing discharge power upon increasing a transportation speed for transporting a printed medium and by gradually reducing the discharge power upon reducing the transportation speed, which makes it possible to maintain wetting tension constant when the transportation speed for transporting a printed medium is increased or reduced. However, with respect to the technology disclosed in Japanese Patent No. 5728876, wetting tension in a printed medium having irregularities is not maintained constant, and poor ink adhesion is exhibited. This may result in ink being removed from a printing base material.

### SUMMARY OF THE DISCLOSURE

An image forming apparatus according to an embodiment of the present disclosure includes a printing section, a UV irradiation section, and a UV control section.

The printing section is configured to be capable of forming an image by applying ink to a printing base material.

The UV irradiation section irradiates the printing base material with ultraviolet rays before the application of the ink to the printing base material.

The UV control section controls a period of time for which the ultraviolet rays are irradiated, on the basis of glossiness of a face of the printing base material, where the ink is applied to the face of the printing base material.

### BRIEF DESCRIPTION OF THE DRAWINGS

FIG. 1 schematically illustrates a configuration of an image forming apparatus.

FIG. 2 is a block diagram illustrating the configuration of the image forming apparatus.

FIG. 3 illustrates an experiment result in Example 1.

FIG. 4 illustrates an experiment result in Comparative Example 1.

### DETAILED DESCRIPTION OF THE EXEMPLARY EMBODIMENTS

Hereinafter, embodiments according to the present disclosure will be described with reference to the drawings.

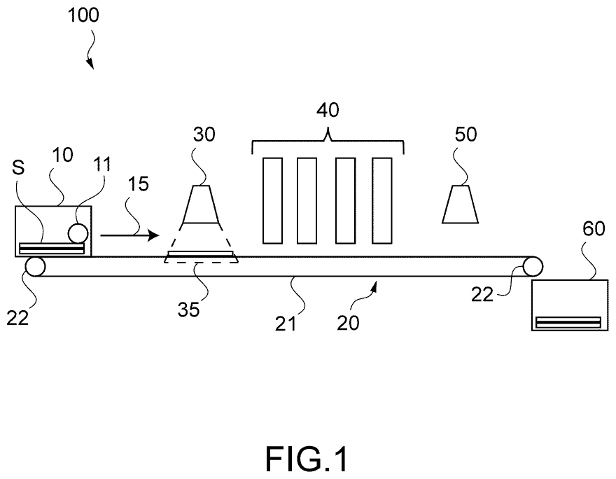

FIG. 1 schematically illustrates a configuration of an image forming apparatus.

As illustrated in FIG. 1, an image forming apparatus 100 includes a printing-base-material feeder 10, a transportation section 20, a UV lamp 30, a printing section 40, a drying section 50, and a printing-base-material discharge portion 60.

The printing-base-material feeder 10 stores therein a printing base material S, and includes a roller 11 used to feed the printing base material S. In the present embodiment, the printing-base-material feeder 10 rotates the roller 11 under print instructions from the image forming apparatus 100 to feed the printing base material S in a sheet proceeding direction (refer to an arrow 15).

In the present embodiment, the printing base material S is a plastic film. Note that the printing base material S is not limited to the plastic film, and any printing base material having the property that irregularities are formed on a surface of the printing base material S by the printing base material S being irradiated with UV rays may be used.

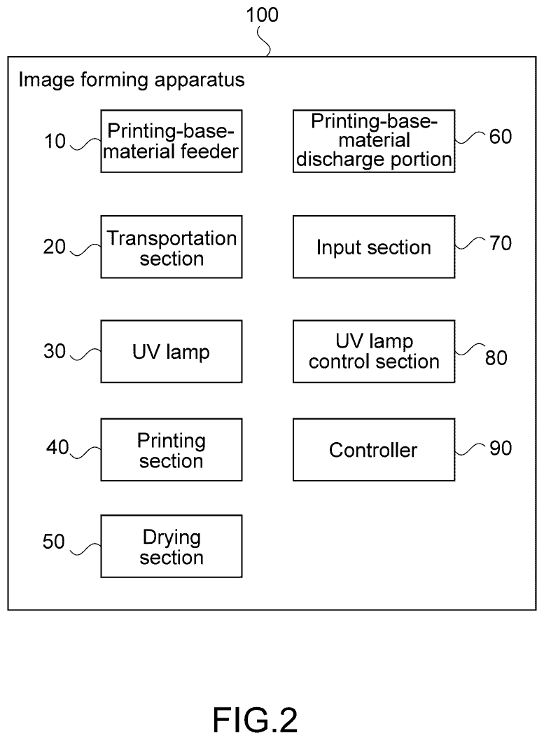

The transportation section 20 includes a transportation belt 21 used to transport the printing base material S, and a roller 22 used to drive the transportation belt 21 in order to transport the printing base material S in the sheet proceeding direction. In the present embodiment, the transportation section 20 transports the printing base material S according to a transportation speed for transporting the printing base material S that is input by an input section 70 (refer to FIG. 2). Further, in the present embodiment, the transportation section 20 stops the transportation belt 21 during a UV treatment performed by a UV lamp on the printing base material S. For example, the transportation section 20 stops after transporting the printing base material S such that the printing base material S is within a region 35 in which the printing base material S is irradiated with UV rays.

Further, the transportation section 20 is provided with, for example, an air hole (not illustrated) used to cause the printing base material S to stick to the transportation belt 21. For example, innumerable holes are formed in the transportation belt 21, and air may be sucked in by, for example, a pump (not illustrated) to cause the printing base material S to stick to the transportation belt 21. Moreover, the transportation section 20 may include an inverting mechanism used to invert the printing base material S (for example, from a front-side face to a backside face).

The UV lamp 30 performs a UV treatment to irradiate the printing base material S with ultraviolet rays. In the present embodiment, the UV lamp 30 is arranged upstream of the printing section 40 described later in a transportation direction, and before printing on the printing base material S, the UV lamp 30 performs UV irradiation according to a period of time (hereinafter referred to as a UV treatment time) for which a UV treatment based on glossiness of a print-target face of the printing base material S is performed. For example, a low-pressure mercury lamp is used as the UV lamp 30.

The printing section 40 is configured to be capable of forming an image by applying ink to the printing base material S. For example, the printing section 40 includes head units that are respectively provided with inks of cyan, yellow, magenta, and black, a plurality of nozzles respectively used to eject the inks, drive circuits that respectively control amounts of the inks to be ejected, and pressurizing elements that respectively apply pressure to the nozzles. Note that the number of ink colors included in the printing section 40 is not limited to four, and may be less than or greater than four. For example, the printing section 40 may include white ink.

Further, the ink ejected by the printing section 40 is, for example, an aqueous pigmented ink-jet ink that contains at least pigment and water. Furthermore, with respect to, for example, a binder, a solvent, and a surfactant that are included in the ink, their types, their amounts contained, and their compositions are not limited. Furthermore, the ratio between pigment and a binder, and densities of the pigment and the binder, and others are also not limited. Further, the ink does not necessarily have to be a water-based ink. The ink may further include known additives such as a solubility stabilizer, an anti-drying agent, an antioxidant, a viscosity modifier, a pH adjuster, and a fungicide as necessary.

The drying section 50 dries ink ejected onto the printing base material S. Note that a method for drying ink that is performed by the drying section 50 is not limited. For example, a halogen heater, or a fan that sends heated air may be used, or a mechanism that heats the transportation belt in advance may be used.

The printing-base-material discharge portion 60 stores therein the printing base material S, where ink ejected onto the printing base material S is dried by the drying section 50 to be fixed to the printing base material S.

FIG. 2 is a block diagram illustrating a configuration of the image forming apparatus 100.

As illustrated in FIG. 2, the image forming apparatus 100 includes the printing-base-material feeder 10, the transportation section 20, the UV lamp 30, the printing section 40, the drying section 50, the printing-base-material discharge portion 60, the input section 70, a UV lamp control section 80, and a controller 90.

The input section 70 includes, for example, a display and a touchscreen that are provided to the image forming apparatus 100, and receives an operation input by a user. In the present embodiment, glossiness of a printing base material is input to the input section 70. Data of the input glossiness of the printing base material is output to the UV lamp control section 80. Further, raw materials of the printing base material and a transportation speed for transporting the printing base material are input to the input section 70. The transportation speed for transporting the printing base material is output to the transportation section 20.

The UV lamp control section 80 controls a UV treatment time. In the present embodiment, the UV lamp control section 80 calculates the UV treatment time with reference to, for example, a table stored in the controller 90 described later, on the basis of the input glossiness of the printing base material.

Further, in the present embodiment, when the input glossiness of the printing base material is greater than or equal to a specified threshold, the UV lamp control section 80 calculates, on the basis of the input glossiness, a period of time for which ultraviolet rays are irradiated. For example, the specified threshold is 30.

Furthermore, in the present embodiment, output of UV rays irradiated by the UV lamp 30 is maintained constant. For example, the UV lamp 30 may be arranged such that a distance between the UV lamp 30 and the transportation section 20 transporting a printing base material is constant at all times. Further, for example, an ultraviolet illuminance of UV rays irradiated by the UV lamp 30 may be 20 mW/cm². Note that the ultraviolet illuminance is illuminance of ultraviolet rays irradiated onto a region at an irradiation distance of 10 mm with a center position of 50 mm×50 mm.

Further, in the present embodiment, a peak of a wavelength of UV rays irradiated by the UV lamp 30 is less than or equal to 200 nm.

The controller 90 controls the image forming apparatus 100. For example, the controller 90 includes a computation section and a storage (not illustrated). The computation section is, for example, a central processing unit (CPU). The storage includes a storage medium such as a read only memory (ROM), a random access memory (RAM), or an electrically erasable programmable read only memory (EEPROM). The computation section performs various processes by reading a control program stored in the storage and executing the control program.

Further, for example, the controller 90 may form an image by performing control such that an ejection signal depending on a pixel is supplied to the printing section 40 on the basis of input image data to apply ink to the printing base material S and such that a drying process is performed by the drying section 50 at an appropriate timing. Moreover, the controller 90 may control a temperature of the drying section 50, a degree of supply of heated air by the drying section 50, a transportation speed at which the transportation section 20 transports a printing base material, and stop of the transportation performed by the transportation section 20.

Note that the configuration of the image forming apparatus 100 is not limited. For example, the input section 70 may be configured to be capable of not only inputting glossiness but also selecting data of an image printed on a printing base material and selecting various functions regarding printing functions for, for example, the number of sheets of paper printed and double-sided printing.

### Examples

Examples of the present disclosure are described below. Note that Examples described below are merely examples of the present disclosure, and the present disclosure is not limited to configurations of Examples described below.

### Measurement of Glossiness

In the present disclosure, the glossiness of a glossiness-measurement-target printing base material was measured at an angle of 20 degrees using a gloss meter (J480T-268, Elcometer Limited), where the printing base material was placed on a white portion of a contrast ratio testing strip (produced by TP Giken).

Conditions for Experiment of Tape Stripping and Method for Evaluating Tape Stripping

In the present disclosure, a plastic film was used as the printing base material. For example, “Lumirror #50-S10” produced by Toray Industries, Inc., “TORAYFAN #50-2500H” produced by Toray Industries, Inc., and “GW703 #135” produced by Toyobo Co., Ltd. were used.

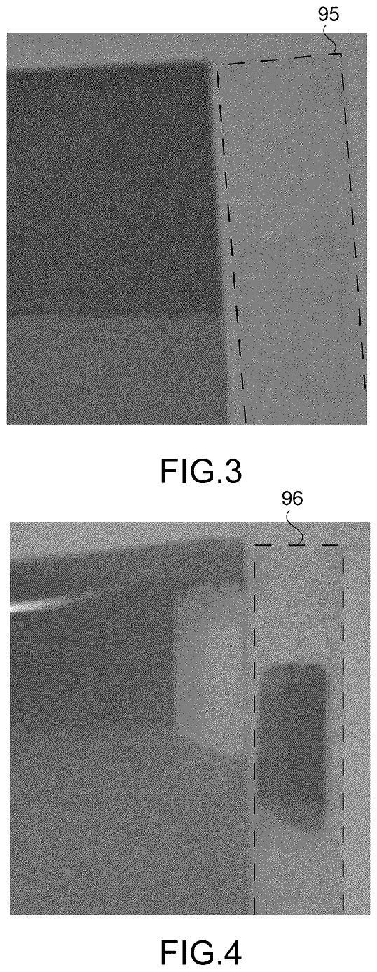

As illustrated in FIGS. 3 and 4, solid cyan with one dot lines on the printing base material was obtained by printing cyan on the printing base material at 600 dpi. Further, in the present disclosure, the approach provided by JIS K5600 was adopted, where there was no crosscut. A tape was applied to the printing base material on which the printing was performed, the tape was firmly rubbed with fingertips, and the tape was stripped within five minutes after the application of the tape. Here, an end of the tape was held at an angle as close to 60 degrees as possible to strip the tape from the printing base material with certainty in 0.5 seconds to 1.0 second.

Further, an unused tape and a tape on which a stripping test was performed were applied to copy sheets of paper (C2, FUJIFILM Business Innovation Corp.), and an image density of cyan was measured using an image densitometer (FD-5, Konica Minolta, Inc.). A (particularly good) was given when a difference between an image density of the tape on which the stripping test was performed, and an image density of the unused tape was less than 0.05, B (good) was given when the difference was less than 0.15, and C (poor) was given when the difference was greater than or equal to 0.15.

### Examples 1 to 3 and Comparative Examples 1 to 3

FIG. 3 illustrates an experiment result in Example 1. FIG. 4 illustrates an experiment result in Comparative Example 1.

In Example 1, “Lumirror #50-S10” produced by Toray Industries, Inc. was used as the printing base material. Glossiness of this printing base material is 133.6. Further, the UV treatment time is 2.0 minutes.

In Example 2, “TRAYFAN #50-2500H” produced by Toray Industries, Inc. was used as the printing base material. Glossiness of this printing base material is 89.7. Further, the UV treatment time is 1.0 minute.

In Example 3, “GW703 #135” produced by Toyobo Co., Ltd. was used as the printing base material. Glossiness of this printing base material is 31.4. Further, the UV treatment time is 0.5 minutes.

In Comparative Example 1, “Lumirror #50-S10” produced by Toray Industries, Inc. was used as the printing base material. The glossiness of this printing base material is 133.6. Further, the UV treatment time is 0 minutes (no UV treatment is performed).

In Comparative Example 2, “TRAYFAN #50-2500H” produced by Toray Industries, Inc. was used as the printing base material. The glossiness of this printing base material is 89.7. Further, the UV treatment time is 0 minutes (no UV treatment is performed).

In Comparative Example 3, “GW703 #135” produced by Toyobo Co., Ltd. was used as the printing base material. The glossiness of this printing base material is 31.4. Further, the UV treatment time is 0 minutes (no UV treatment is performed).

| | | | UV | |
|---|---|---|---|---|
| | | | treatment | |
| | | | time | |
| | Maker / Model number | Gloss | (min) | Adhesion |
| Example 1 | Toray Lumirror #50-S10 | 133.6 | 2.0 | A |
| Example 2 | Toray TORAYFAN #50-2500H | 89.7 | 1.0 | A |
| Example 3 | Toyobo GW703#135 | 31.4 | 0.5 | A |
| Comparative | Toray Lumirror #50-S10 | 133.6 | 0 | C |
| Example 1 | | | | |
| Comparative | Toray TORAYFAN #50-2500H | 89.7 | 0 | C |
| Example 2 | | | | |
| Comparative | Toyobo GW703#135 | 31.4 | 0 | B |
| Example 3 | | | | |

In Examples 1 to 3, particularly good adhesion was exhibited. As illustrated in FIG. 3, ink did not stick to the tape (refer to a dotted line 95) when the tape stripping test was performed. Further, as illustrated in FIG. 4, in Comparative Examples 1 to 3, ink stuck to the tape (refer to a dotted line 96) when the tape stripping test was performed.

This shows that a degree of adhesion of ink to a printing base material is lower if a degree of glossiness of a plastic film is higher, but the adhesion can be improved by performing a UV treatment. These phenomena can be explained using an anchor effect. A surface of a printing base material having a low degree of glossiness has microscopic irregularities, and ink enters spaces formed by the irregularities. This results in increasing the degree of adhesion. However, a printing base material having a high degree of glossiness has a smooth surface, and a degree of adhesion of ink to the printing base material is low.

Further, the following two effects provide a mechanism for improving adhesion of ink to a printing base material by performing a UV treatment. The first effect is a physical effect provided by forming microscopic irregularities on a surface of the printing base material, and the second effect is a scientific effect provided by forming, for example, a carbonyl group and a carboxyl group that are polar groups as well as nitride. The physical effect enables ink to easily enter a surface of a printing base material (a plastic film) due to irregularities on the surface. This results in improving adhesion. Further, the scientific effect improves wettability since the polar groups are hydrophilic. This results in improving adhesion.

As described above, the image forming apparatus 100 according to the present embodiment includes the printing section 40 configured to be capable of forming an image by applying ink to the printing base material S, the UV lamp 30 irradiating the printing base material S with ultraviolet rays before the application of the ink to the printing base material S, and the UV lamp control section 80 controlling a period of time for which ultraviolet rays are irradiated, on the basis of glossiness of an ink-application-target face of the printing base material S. As a result, adhesion of ink to a printing base material is improved by performing a UV treatment, even when a degree of glossiness of the printing base material is high. This makes it possible to prevent dried ink from being removed from a printing base material.

In related art, poor adhesion of ink to a printing base material may result in the ink being removed from the printing base material. The adhesion of ink to a printing base material is related to glossiness of a surface of the printing base material. In the case of, for example, a printing base material such as a plastic film, a degree of adhesion of ink to the printing base material is low when a degree of glossiness is high. Further, a printing base material having a low degree of glossiness has microscopic irregularities on its surface. Thus, the anchor effect improves ink adhesion. On the other hand, there is a method that includes, for example, performing corona discharge on a printing base material in order to improve wettability of the printing base material for ink. However, sufficient adhesion is not secured for the printing base material having irregularities. This results in ink being removed.

In the present technology, when the printing base material is a plastic film and when the printing base material has a high degree of glossiness, that is, when the printing base material has a surface having a small number of irregularities, a UV treatment to irradiate the printing base material with ultraviolet rays is performed to form microscopic irregularities on the surface of the printing base material and to form, for example, a carbonyl group and a carboxyl group that are polar groups as well as nitride. This makes it possible to improve adhesion of ink to a printing base material. This also makes it possible to prevent dried ink from being removed from a printing base material.

### Other Embodiments

The present technology is not limited to the embodiments described above, and can achieve various other embodiments.

In the embodiments described above, transportation of the printing base material S by the transportation section 20 is stopped during execution of a UV treatment. Without being limited thereto, the printing base material S may also be transported during execution of the UV treatment. When, for example, the UV treatment time is two minutes, a transportation speed at which the transportation section 20 performs transportation may be controlled such that the time necessary for the printing base material to pass through the region 35 in which ultraviolet rays are irradiated by the UV lamp 30, is two minutes.

In the embodiments described above, output of UV rays irradiated by the UV lamp 30 is maintained constant. Without being limited thereto, the output of UV rays may be controllable. For example, a distance between the UV lamp 30 and the transportation section 20 (the printing base material S) may be controllable, or illuminance of ultraviolet rays output by the UV lamp 30 may be controllable. In other words, the UV lamp control section 80 may be capable of controlling not only the UV treatment time but also illuminance of ultraviolet rays irradiated onto the printing base material S, on the basis of glossiness of the printing base material S.

It should be understood by those skilled in the art that various modifications, combinations, sub-combinations and alterations may occur depending on design requirements and other factors insofar as they are within the scope of the appended claims or the equivalents thereof.

What is claimed is:

1. An image forming apparatus, comprising:
a printing section configured to be capable of forming an image by applying ink to a printing base material;
a UV irradiation section that irradiates the printing base material with ultraviolet rays before the application of the ink to the printing base material; and
a UV control section that controls a period of time for which the ultraviolet rays are irradiated, on a basis of glossiness of a face of the printing base material, the ink being applied to the face of the printing base material.

2. The image forming apparatus according to claim 1, wherein
a peak of a wavelength of the ultraviolet rays is less than or equal to 200 nm.

3. The image forming apparatus according to claim 1, further comprising an input section configured to be capable of inputting the glossiness, wherein
on a basis of the input glossiness, the UV control section calculates the period of time for which the ultraviolet rays are irradiated.

4. The image forming apparatus according to claim 3, wherein
when the input glossiness is greater than or equal to a specified threshold, the UV control section calculates, on the basis of the input glossiness, the period of time for which the ultraviolet rays are irradiated.

5. The image forming apparatus according to claim 1, wherein
the ink includes an aqueous pigmented ink that contains at least pigment and water.

6. The image forming apparatus according to claim 1, wherein
the printing base material includes a plastic film.
